(19) United States
(12) Patent Application Publication
(10) Pub. No.: US 2007/0017746 A1
(43) Pub. Date: Jan. 25, 2007

(54) Surface treatment installation having a lifting station

(76) Inventor: Joerg Robbin, Ammerbuch (DE)

Correspondence Address: FACTOR & LAKE, LTD, 1327 W. WASHINGTON BLVD., SUITE 5G/H, CHICAGO, IL, 60607, US

(21) Appl. No.: 11/189,087

(22) Filed: Jul. 25, 2005

(51) Int. Cl. B66F 7/00

(52) U.S. Cl. 187/203

(57) ABSTRACT

A surface treatment installation, in particular for the treatment of vehicle bodies, comprises a lifting station (24, 25) for vertically displacing an object (12). The lifting station has a stationary supporting structure (34) with two vertical guiding uprights (26, 28), and a lifting slide (40) which is supported on the supporting structure (34) via guiding rollers (64, 66, 68, 70) bearing against the guiding uprights (26, 28) at least at two points. The lifting station further has a loading arm (54) which is fastened to the lifting slide (40) and serves for receiving the object (12). According to the invention, it is provided that at least one guiding roller (64, 66, 68, 70; 64a; 64b; 64c; 64d; 66d) has a non-cylindrical shape in order to obtain a guiding direction different from a radial direction. This enables a vertical guidance of the lifting slide (40) with fewer guiding rollers.

The invention relates to a surface treatment installation, in particular for the treatment of vehicle bodies, having a lifting station for vertically displacing an object, the lifting station comprising:
a) a stationary supporting structure with two vertical guiding uprights,
b) a lifting slide which is supported on the supporting structure via guiding rollers bearing against the guiding uprights at least at two points, and
c) a loading arm which is fastened to the lifting slide and serves for receiving the object.

Surface treatment installations of this type, as are known through use in the prior art, serve for treating surfaces of objects in various ways, for example by applying paints and other coatings. Installations of this type frequently include a plurality of individual treatment stations for different treatment steps, for example preparation, painting and drying. The objects to be treated, which can, for example, be motor vehicle bodies or other sheet-metal parts, are conveyed for this purpose with the aid of a conveying system from treatment station to treatment station.

The surface treatment installation here also includes those regions between and following the treatment stations in which the objects to be treated are merely conveyed, temporarily stored or sorted. The conveyance, temporary storage and sorting of the objects to be treated takes place frequently at a plurality of levels one above the other. In these cases, it is necessary to vertically displace the objects between different levels.

A vertical displacement is also necessary when individual stations of the surface treatment installation are for certain reasons arranged at different levels relative to other stations. If the objects in one station are to be treated, for example, with gases which are heavier than a surrounding atmosphere, then such a treatment is frequently carried out in a sunken region, for example in a kind of trough, so that as little of the gases as possible can escape via inlet and outlet openings of the region. In the case of a treatment with lighter gases or with hot air, by contrast, it is for the same reasons more favourable to arrange the treatment region higher.

Lifting stations known in the prior art which are provided for vertically displacing objects in surface treatment installations have a lifting slide which is guided in the vertical direction (lifting direction) with the aid of cylindrical guiding rollers. This means that the lifting slide can only move in the vertical direction, while in the directions perpendicular thereto it is fixed to a supporting structure. The supporting structures of the known lifting stations include for this purpose vertical guiding uprights of rectangular cross-section, against which the guiding rollers of the lifting slide bear. At total of four guiding rollers bear against each guiding upright here, namely one rear and one lateral guiding roller in an upper vertical position of the lifting slide and one front and one lateral guiding roller in a lower vertical position.

Lifting stations of this type are subject to very exacting requirements in terms of reliability. This is due to the fact that the objects are conveyed one after the other through the individual treatment stations. A failure of a single lifting station therefore generally leads to the stoppage of the entire surface treatment installation. Furthermore, lifting stations must be designed such that soiling of the surfaces to be treated is avoided. Such soiling may result, for example, from lubricants used to lubricate movable parts of the lifting station.

Against this background, the object of the invention is to specify a surface treatment installation having a lifting station which is of simple construction and requires little maintenance.

This object is achieved in the case of a surface treatment installation of the type mentioned at the beginning in that at least one guiding roller has a non-cylindrical shape in order to obtain a guiding direction different from a radial direction. The direction perpendicular to the axis of rotation of the guiding rollers is referred to as the radial direction here.

The use of non-cylindrical guiding rollers has the advantage that guidance of the lifting slide on the supporting structure can be achieved with fewer guiding rollers than was known hitherto in the prior art. While in the known lifting stations guidance in two different directions always required two guiding rollers as well, the same action can be achieved with only one guiding roller with the configuration of the guiding rollers according to the invention. The total number of guiding rollers required can thus be reduced and in certain circumstances even halved. The weight and complexity of the lifting station are correspondingly reduced, and this has a favourable effect on the production costs and the maintenance required.

Generally, the shape of the at least one guiding roller can be described by rotation of a curved radial contour about an axis of rotation of the at least one guiding roller. This radial contour can, for example, be circular-arc-shaped, parabolic, hyperbolic or else defined by any other curved line.

If the at least one guiding roller is to bear against the guiding upright along a line, then the cross-section of the upright—or to be more precise its portion which faces the guiding roller—must have substantially the same shape as the radial contour. If, by contrast, it is sufficient for the at least one guiding roller to bear against the guiding upright in the region of at least two points, then the cross-section and the radial contour can also be shaped differently.

It is particularly advantageous if the cross-section of the guiding upright against which the at least one guiding roller bears is circular. Guiding uprights of circular cross-section can be produced inexpensively from steel tubes and furthermore have the advantage that rigidly connected constructions can be obtained with relatively low material usage. The entire supporting structure can thereby be realised substantially slimmer overall and optionally with fewer stiffening elements than is possible when using rectangular profiles for instance. The use of round tubes furthermore has the advantage that dirt does not accumulate as easily and, moreover, can be removed more simply.

Guiding rollers of non-cylindrical shape do not, however, necessarily have to have a curved radial contour. For example, a guiding direction different from a radial direction can likewise be obtained with a guiding roller which has at least one conical portion. Furthermore, it is possible to use guiding rollers which have a cylindrical portion adjoined by a kind of flange, which may be conical, but also non-conical.

In order to obtain optimum load distribution, it is expedient if two guiding rollers bear against that side of the guiding uprights which face the lifting slide, and two guiding rollers bear against that side of the guiding uprights which faces away from the lifting slide. The guiding rollers which bear against that side of the guiding uprights which faces the lifting slide should then be arranged below the guiding rollers which bear against that side of the guiding uprights which faces away from the lifting slide.

By using guiding rollers which are mounted in sliding bearings, a further reduction of the maintenance required is possible. Moreover, guiding rollers mounted in sliding bearings have the advantage that it is scarcely possible for splashes of lubricant to emanate from them. Costly protective and cleaning measures which would otherwise be necessary can therefore be optionally dispensed with.

The at least one guiding roller can have a rolling surface which bears against the guiding upright and is produced from a plastic. This is advantageous in particular with regard to a low weight of the lifting slide.

The lifting slide can be driven in many different ways. Suitable examples are a rack-and-pinion drive or hydraulic drive.

However, a drive with the aid of a traction means which serves for raising and lowering the lifting slide and connects the lifting slide to a drive motor is particularly simple and requires little maintenance. Since it is generally unfavourable to arrange the drive motor at the upper end of the lifting station, the traction means can be guided via a deflection roller arranged at the upper end of the lifting station. The drive motor can then be arranged lower down and in particular in the vicinity of the lower end of the lifting station. This is advantageous insofar as the drive motor is then more readily accessible for maintenance work.

Suitable examples of traction means are chains made of steel or plastic or belts made of textiles, plastics or steel. Particular preference is given, however, to the use of a cable or a belt as the traction means, since these traction means have a low dead weight and do not require lubrication. Steel chains in particular frequently have the drawback that lubricants become detached as splashes during the movement of the chain and soil the objects to be treated. The use of traction means additionally has the advantage that it is thus possible to realise in a simple manner a block-and-tackle which reduces the force required to raise the lifting slide.

If the drive motor is not to be arranged in the immediate vicinity of the lifting station but at a distance from it, then this drive motor can be separated from the guiding uprights by a wall. The wall is then to be provided with openings, through which the traction means is guided through the protective wall. In this case, a deflection roller which deflects the traction means can be situated between the guiding uprights and the openings in the protective wall.

To determine the height of the lifting slide relative to a reference point, an incremental sensor can, for example, be provided. The reference point here can, for example, be defined by the level of a conveying system arranged upstream or downstream. As height-measuring device, particular preference is given, however, to the use of a cable-controlled sensor, known per se, which enables a highly precise absolute valve measurement based on the reference point. A cable-controlled sensor has, inter alia, the advantage that the cable drums with the associated rotary angle sensor can also be arranged further away, for example separated from the supporting structure by a protective wall. The cable-controlled sensor can cooperate with a stationary reference point switch which enables alignment of the height information ascertained by the cable-controlled sensor with the reference height at which the reference point switch is arranged.

In addition, at least one mechanical limit cutout can be fastened to the upper end of the lifting station, this cutout switching off the drive motor as soon as the lifting slide has reached the top dead centre.

The supporting structure can be connected to a stationary supporting arrangement in the vicinity of the upper end of the lifting station, which supporting arrangement can, for example, be a steel structure or a building wall. As an alternative to this, it is also possible to connect the guiding uprights to a horizontal foot, and this also includes the case where the guiding uprights are designed integrally with such a foot. The foot can be fastened to a building floor and extends at least in the direction of the loading arm as well. In this way, the lifting station can be securely anchored irrespective of the local conditions of a surrounding building or another stationary supporting arrangement.

Further advantages and features of the invention will emerge from the following description of the exemplary embodiments with reference to the drawings, in which:

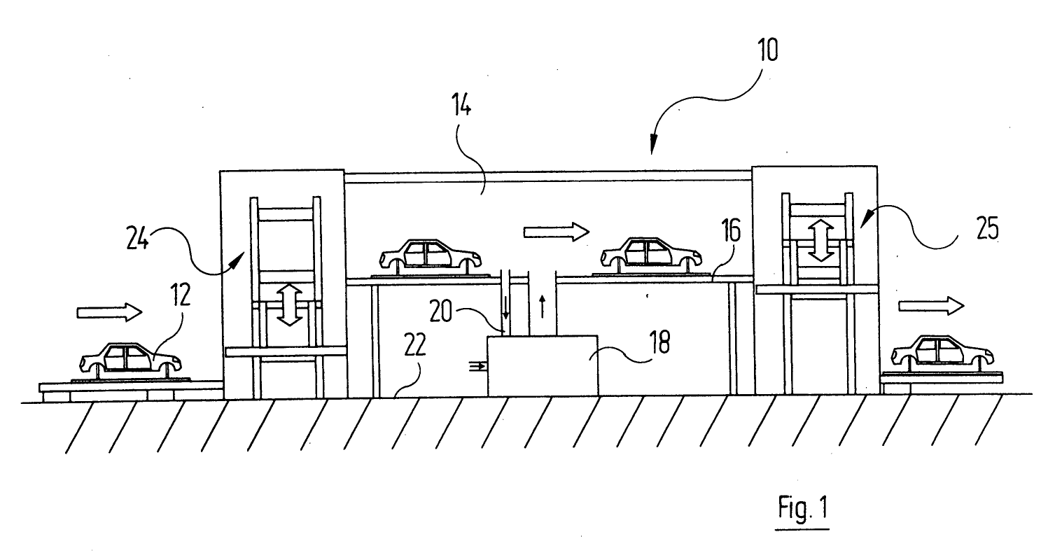

FIG. 1 shows a schematic side view of a part of a painting installation, according to the invention, for motor vehicle bodies;

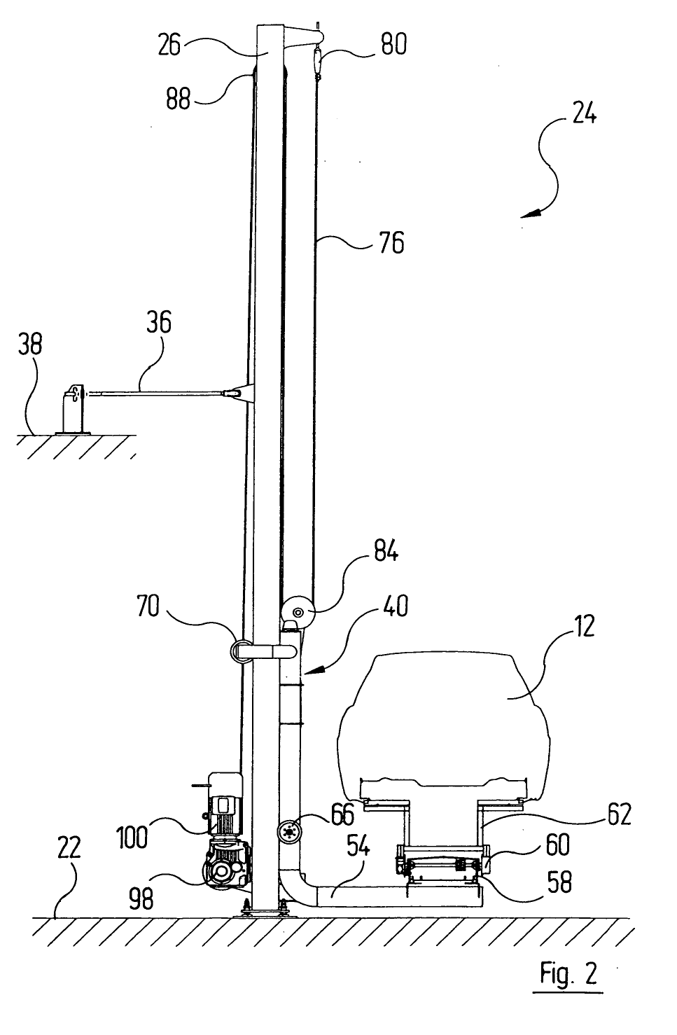

FIG. 2 shows a side view of a lifting station which is part of the painting installation shown in FIG. 1, a loading arm of the lifting apparatus being situated in the lower lifting position;

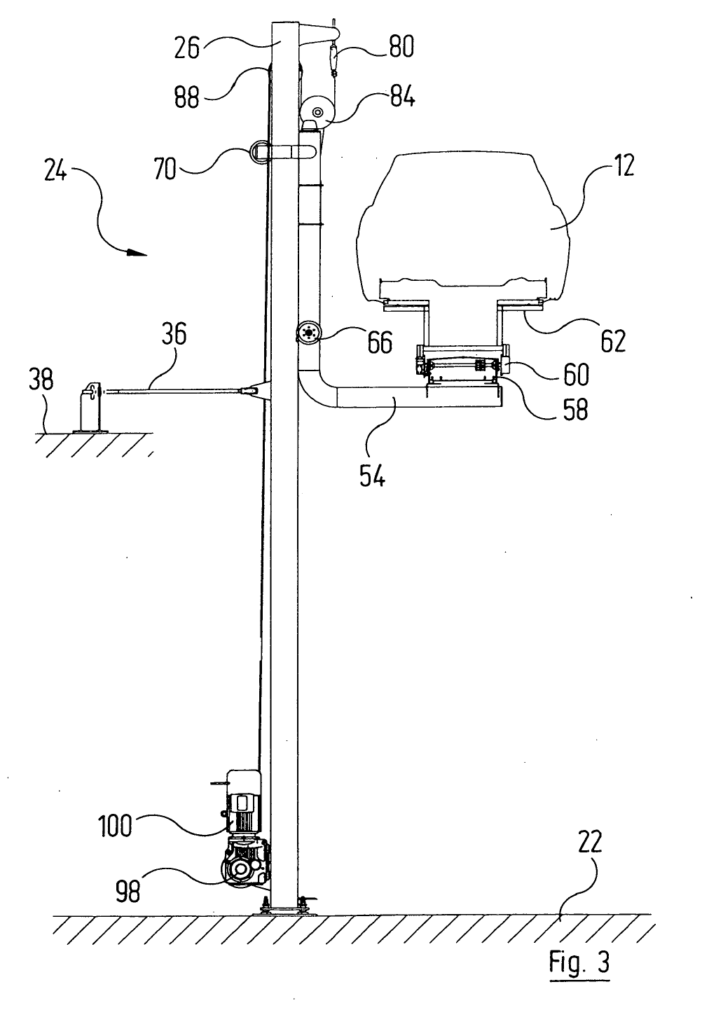

FIG. 3 shows the side view of the lifting station shown in FIG. 2, the loading arm being situated in the upper lifting position;

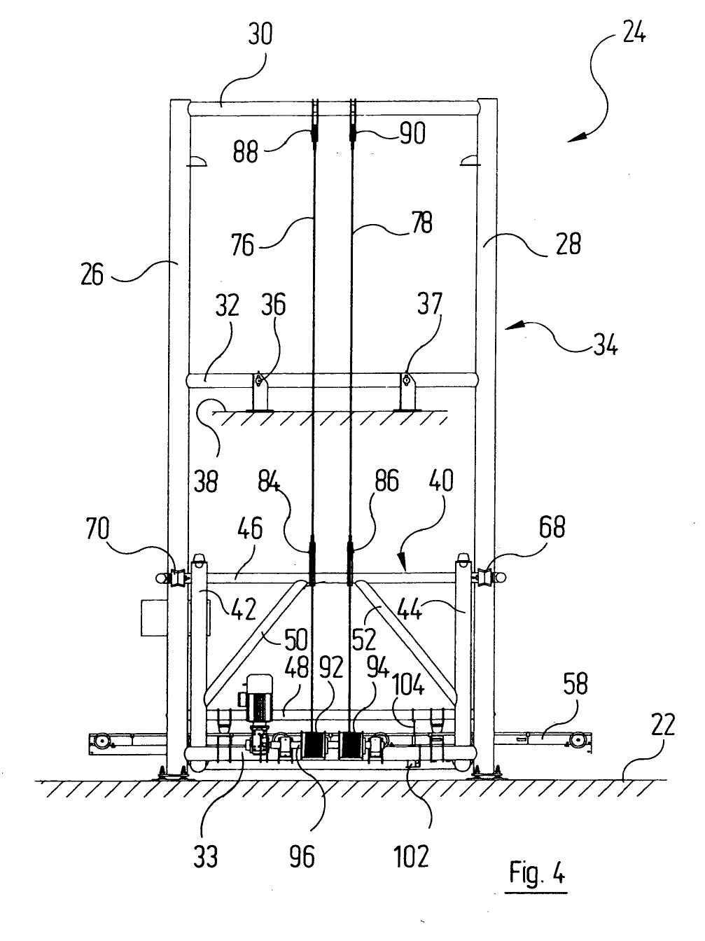

FIG. 4 shows a rear view of the lifting station shown in FIG. 2 (without the vehicle body);

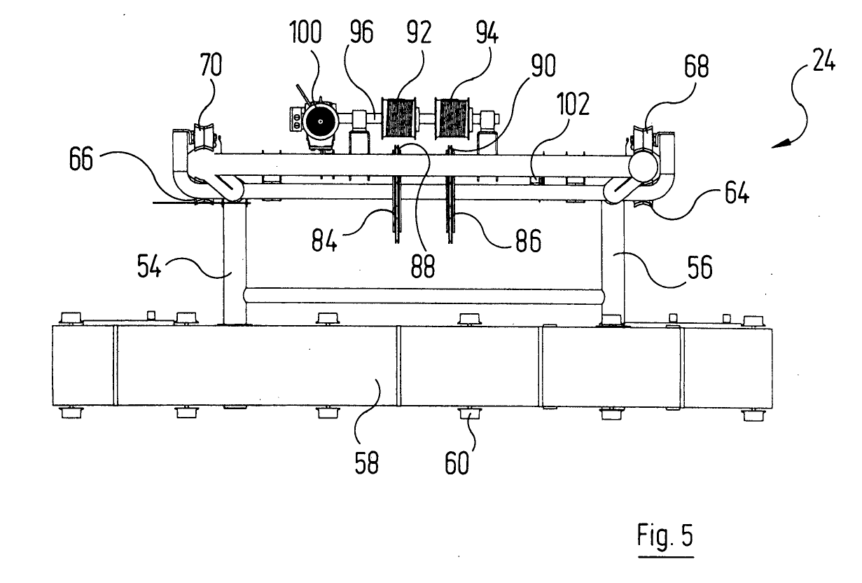

FIG. 5 shows a plan view of the lifting station shown in FIG. 2 (without the vehicle body);

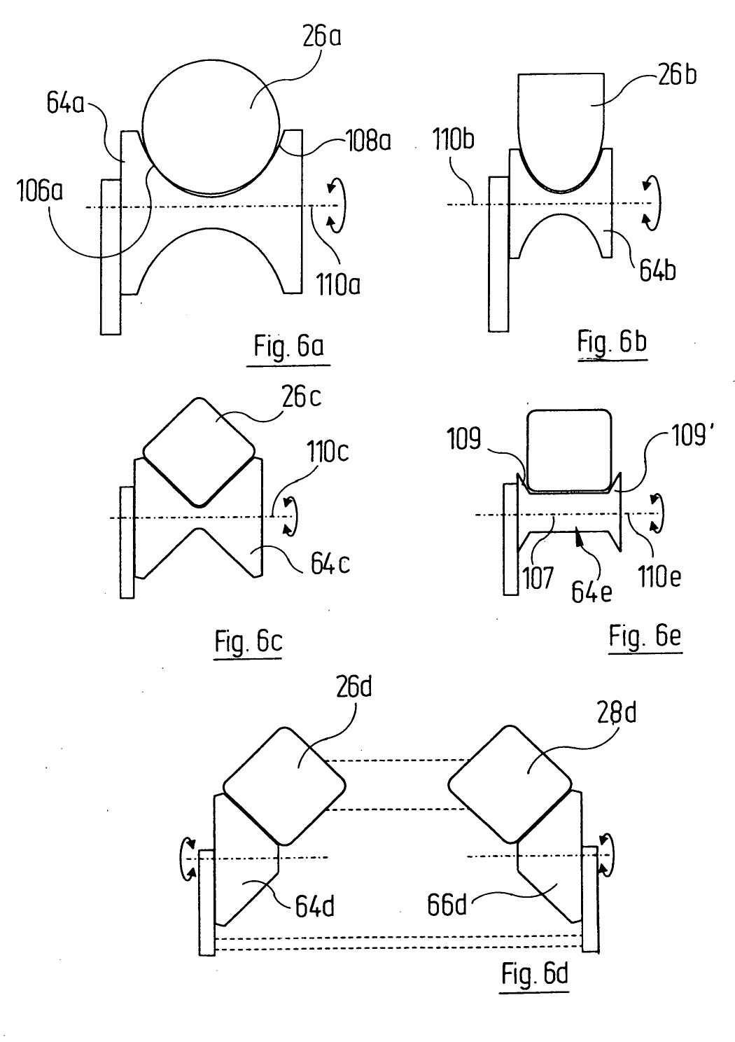

FIGS. 6a to 6e show different configurations of guiding rollers and guiding upright profiles;

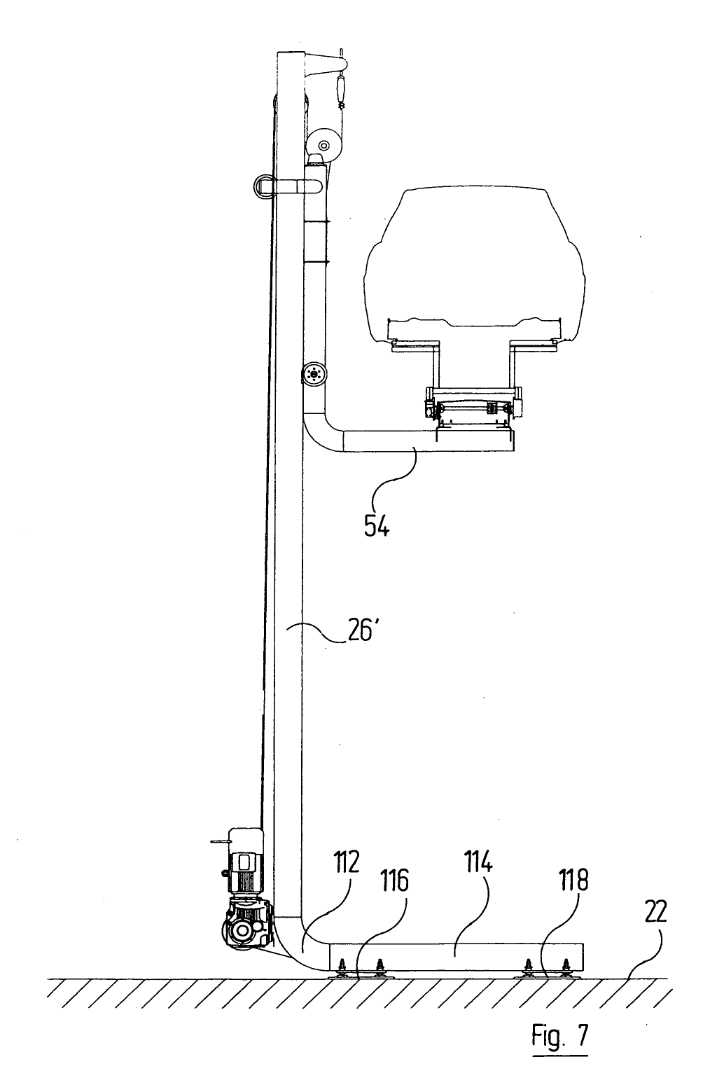

FIG. 7 shows a variant of the lifting station shown in FIG. 2, in which guiding uprights of the lifting station are fastened to a building floor via a horizontal foot;

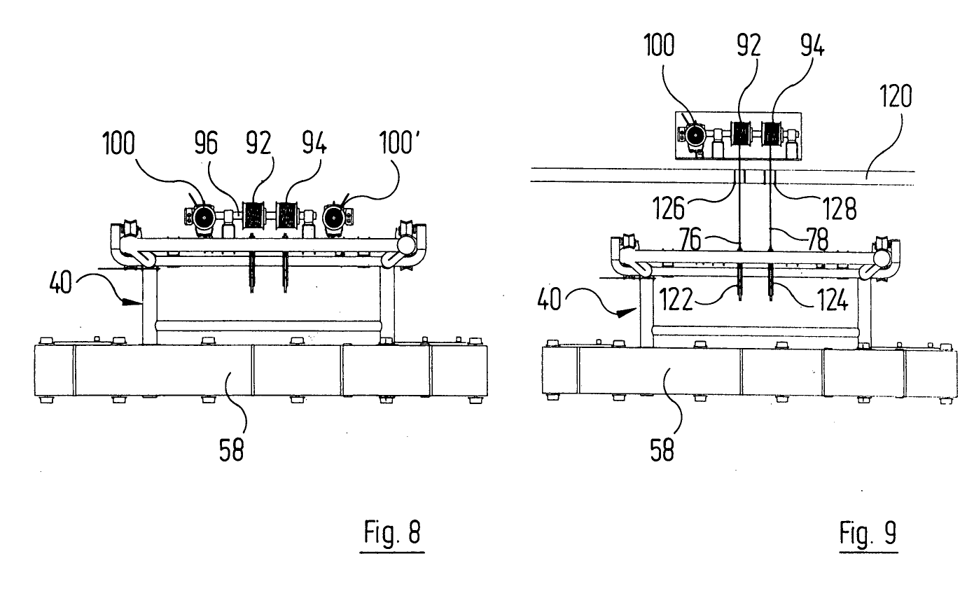

FIG. 8 shows a plan view of a further variant of the lifting station shown in FIG. 1, which has an additional redundant drive motor;

FIG. 9 shows a still further variant of the lifting station shown in FIG. 1, in which a drive unit is separated form the remaining parts of the lifting station by a wall.

FIG. 1 shows a part of a painting installation for motor vehicle bodies in a highly schematic longitudinal section not to scale. The part shown in FIG. 1 is a drying region 10 for drying previously coated motor vehicle bodies, upstream and downstream of which region are respectively arranged two lifting stations, which are to be explained in more detail.

The drying station 10 includes an elongated housing 14, on the floor of which is fastened a conveying device, indicated by 16, for the motor vehicle bodies 12. This conveying device 16 may, for example, be a roller conveyor, a chain conveyor or a combination of both. The drying region 10 further includes a merely schematically indicated heating device 18, which serves to blow hot air from below into distribution channels running along the long sides of the housing 14. The hot air, enriched with solvent vapours, can be led via an outlet 20 back to the heating device 18, by which it is cleaned, heated and led back into the housing 14 again.

The housing 14 is raised by a few metres relative to a floor 22 of a surrounding building. This prevents the hot air introduced into the housing 14 by the heating device 18 from escaping in relatively large quantities from the housing 14 at the entrance and exit thereof. The elevated arrangement of the housing 14 relative to the floor 22 makes it necessary to raise the motor vehicle bodies 12 before they can be conveyed through the drying region 10. Conversely, the motor vehicle bodies 12 have to be lowered at the exit of the drying region 10 again.

For raising and lowering the motor vehicle bodies 12, lifting stations 24 and 25 are respectively provided, the details of which will be explained more fully in the following with reference to FIGS. 2 to 5.

FIGS. 2 to 5 show the lifting station 24 in side view in different lifting positions, a rear view and a plan view, respectively. The lifting station 24 has two vertical guiding uprights 26, 28 which, together with an upper crossmember 30, a middle crossmember 32 and a lower crossmember 33, form a supporting structure 34. The middle crossmember 32 here is connected to a building intermediate ceiling 38 via two fastening struts 36, 37, in order to carry away tilting moments acting on the guiding uprights 26, 28.

The guiding uprights 26, 28 and the crossmembers 30, 32, 33 are each produced from steel tubes of circular cross-section. The small geometrical moment of inertia of the tubes enables a high rigidity of the supporting structure 34 with low material usage.

Explained in more detail, on the guiding uprights 26, 28 is supported a lifting slide 40 which can be moved in the vertical direction and is fixed in the horizontal relative to the supporting structure 34. The lifting slide 40 is composed of two vertical frame parts 42, 44, two horizontal frame parts 46, 48 and two stiffening struts 50, 52. The frame parts 42, 44, 46, 48 and the stiffening struts 50, 52 are likewise produced from round tubes and joined to one another by welding.

Loading arms 54, 56, likewise produced from round tubes, lead off from the vertical frame parts 42, 44 of the lifting slide 40. The loading arms 54, 56 carry a roller conveyor, denoted as a whole by 58, which includes a plurality of axles arranged one after the other. The axles are driven by electric motor and carry rollers 60 at their ends. Since roller conveyors 58 of this type are known as such in the prior art, the explanation of further details thereof will be dispensed with.

For clarity, FIGS. 2 and 3 show a vehicle body 12 fastened on a support, which is also referred to as a skid and is denoted by 62 in the drawings. The skid 62 can be moved in the longitudinal direction of the roller conveyor 58 with the aid of the driven rollers 60.

The lifting slide 40 is supported on the supporting structure 34 via a total of four guiding rollers which bear against the guiding uprights 26, 28 along a circular arc. Two guiding rollers are fastened at the same height in the rear region of the vertical frame parts 42, 44 and bear against the front side of the guiding uprights 26 and 28, respectively. They are therefore referred to as front guiding rollers 64, 66 below. Two further rollers, referred to as rear guiding rollers 68, 70 below, are mounted on angles 72 and 74, respectively, which lead off further up from the vertical frame parts 42, 44 of the lifting slide 40 and which encompass the guiding uprights 26, 28 from the side to such an extent that the rear guiding rollers 68, 70 bear against the rear sides of the guiding uprights 26, 28.

The guiding rollers 64, 66, 68, 70, which each have a rolling surface made of plastic, are mounted in sliding bearings and thus require little maintenance. The shape of the guiding rollers here is chosen such that the rolling surfaces bear against the tubular guiding uprights 26, 28 along circular lines. Since the guiding rollers 64, 66, 68, 70 partly also laterally encompass the guiding uprights 26, 28, the lifting slide 40 is not only secured against tilting about a horizontal tilting axis, but also laterally fixed, i.e. along the longitudinal direction of the crossmembers 30, 32, 33, relative to the supporting structure 34. Further details and variants on the guidance of the guiding rollers 64, 66, 68, 70 on the guiding uprights 26, 28 are explained hereinbelow with reference to FIGS. 6a to 6e.

For raising and lowering the lifting slide 40, a cable drive having two steel cables 76, 78 is provided. The two steel cables 76, 78 are fastened to cable fastenings 80 and 82, respectively, on the upper crossmember 30. The free end of the steel cables 76, 78 is in each case guided in the manner of a simple block-and-tackle via a deflection roller 84 and 86, respectively, which are fastened to the upper horizontal frame part 46 of the lifting slide 40. Via deflection rollers 88, 90 fastened to the upper crossmember 30 of the supporting structure 34, the steel cables 76, 78 are guided downwards again, where they are wound on cable drums 92, 94. The cable drums 92, 94 are jointly driven by a drive shaft 96 which can be set in rotation by a drive motor 100 via gearing 98.

Due to the block-and-tackles realised by the above-described guidance of the steel cables 76, 78, with the aid of the drive motor 100 only half the force is required to raise the lifting slide 40 than would be required if the steel cables 76, 78 were fastened directly to the lifting slide 40 after deflection via the deflection roller 88, 90.

For exact determination of the vertical position of the lifting slide 40, a cable-controlled sensor 102 is provided. The cable-controlled sensor 102 includes a cable drum, on which a thin measuring cable 104 of low linear extensibility is wound. The cable drum can also be arranged further away from the supporting structure 34 if additional deflection rollers are provided. The free end of the measuring cable 104 is connected to the lifting slide 40, here to its lower frame part 48. Spring loading of the drum ensures that the measuring cable 104 is always taut. The drum on which the measuring cable 104 is wound is connected to a rotary sensor which exactly measures the angular position of the drum. In this way, it is possible to precisely determine the vertical position of the lifting slide 40 via the rotary position of the drum. To set a reference point, an additional reference point sensor (not illustrated) can be fastened to the supporting structure 34, this sensor generating a signal when the lifting slide 40 travels past. The positional information ascertained by the cable-controlled sensor in this position can then be aligned with the height at which the reference point sensor is situated.

The cable-controlled sensor 102 is connected to a control means of the lifting station 24. The task of the control means is to control the drive motor 100 in such a way that the lifting slide 40 travels to a specified height, supplied to the control means, with a preset speed profile and the lifting slide 40 stops exactly at the desired specified height.

In the following, it is explained how surface-treated motor vehicle bodies 12 are conveyed through the drying region 10:

An overall control means of the installation ensures that the lifting slide 40 of the lifting station 24 illustrated on the left in FIG. 1 is moved into the lower vertical position when a skid 62 with a vehicle body 12 fastened thereon approaches the lifting station 24. If the roller conveyor 58 which is fastened on the loading arm 54 of the lifting station 24 is situated at the same height as a roller conveyor arranged upstream of the lifting station 24, then the skid 62 with the vehicle body 12 fastened thereon is transferred to the roller conveyor 58 of the lifting station 24. If necessary, the skid 62 can be fixed on the roller conveyor 58, in order to prevent undesired movements of the skid 62 on the roller conveyor 58 during the raising of the lifting slide 40 which now follows.

As soon as the roller conveyor 58 is situated at the height of the conveying system 16, the conveying system 16 takes over the skid 62 with the vehicle body 12 and guides this skid through the housing 14, through which a flow of hot air passed. At the end of the housing 14, the motor vehicle body 12 is lowered with the aid of the second lifting station 25 and transferred to a following conveying section.

FIGS. 6a to 6e show different variants for cross-sections of the guiding uprights 26, 28 and corresponding shapes of the guiding rollers 64, 66, 68, 70.

In the variant shown in FIG. 6a, the guiding upright 26a likewise has a circular cross-section. The guiding roller 64a has a rolling surface 106a which can be described by rotation of a parabola 108a about the axis of rotation 110a of the guiding roller 64a. The guiding roller 64a thus bears at two points against the guiding upright 26a and is thus fixed relative to the latter both in the radial direction and in the axial direction.

FIG. 6b shows a variant in which that surface of the guiding upright 26b which is directed towards the guiding roller 64b is also parabolically curved. Consequently, the guiding roller 64b bears against the guiding upright 26b along a line.

In the variant shown in FIG. 6c, the guiding upright 26c has an approximately square cross-section, but with one edge directed towards the guiding roller 64c.

The variant shown in FIG. 6d largely corresponds functionally to that shown in FIG. 6c. However, the guiding roller 64c from FIG. 6c is divided up into the two guiding rollers 64d and 66d lying at the same height.

In the variant shown in FIG. 6e, the guiding roller 64e includes a cylindrical middle portion 107, the end faces of which are adjoined by conical flanges 109, 109′.

FIG. 7 shows a further variant, in which the guiding uprights 26, 28 are not fastened to a part of a building via fastening struts 36. Instead of this, the guiding upright 26 merges via an angle piece 112 into a foot piece 114, which is connected to the housing floor 22 via floor plates 116, 118. The foot piece 114 can be designed, for example, as a steel profile.

The variant shown in plan view in FIG. 8 differs from the lifting station 24 shown in FIGS. 2 to 4 in that, in addition to the drive motor 100, there is provided a redundant drive motor 100′ which can be coupled to the is drive shaft 96 in the event of failure of the drive motor 100.

In the variant shown in FIG. 9, the drive unit for the lifting slide 40, having the cable drums 92, 94, the drive shaft 96, the gearing 98 and the drive motor 100, is not arranged directly beneath the lifting slide 40, but offset horizontally rearwards from it. This allows the drive unit to be separated from the remaining parts of the lifting station 24 by a partition wall 120. The variant shown in FIG. 9 merely requires additional deflection rollers 122, 124 for the steel cables 76 and 78, respectively, to be provided. These deflection rollers 122, 124 can be arranged, for example, directly above the housing floor 22, but also higher, for instance at the height of the lower crossmember 33. In this variant, the partition wall 120 is provided with openings 126, 128, through which the steel cables 76, 78 can be guided to the cable drums 92, 94.

1. A surface treatment installation having a lifting station for vertically displacing an object, the lifting station comprising:
a stationary supporting structure with two vertical guiding uprights;
a lifting slide which is supported on the supporting structure via guiding rollers bearing against the guiding uprights at least at two points; and,
a loading arm which is fastened to the lifting slide and serves for receiving the object,
wherein
at least one guiding roller has a non-cylindrical shape in order to obtain a guiding direction different from a radial direction.

2. The surface treatment installation of claim 1, wherein the shape of the at least one guiding roller is described by rotation of a curved radial contour about an axis of rotation of the at least one guiding roller.

3. The surface treatment installation of claim 2, wherein the radial contour is curved in the shape of a circular arc.

4. The surface treatment installation of claim 1 wherein the guiding uprights, against which the at least one guiding roller bears, has a cross-section which is in the shape of a circular arc at least towards the at least one guiding roller.

5. The surface treatment installation of claim 1, wherein the at least one guiding roller has at least one conical portion.

6. The surface treatment installation of claim 1, wherein two guiding rollers bear against that side of the guiding uprights which faces the lifting slide, and two guiding rollers bear against that side of the guiding uprights which faces away from the lifting slide.

7. The surface treatment installation of claim 6, wherein the guiding rollers which bear against that side of the guiding uprights which faces the lifting slide are arranged below the guiding rollers which bear against that side of the guiding uprights which faces away from the lifting slide.

8. The surface treatment installation of claim 1, wherein the at least one guiding roller is mounted in a sliding bearing.

9. The surface treatment installation of claim 1, wherein the at least one guiding roller has a rolling surface which bears against the guiding upright and is produced from a plastic.

10. The surface treatment installation of claim 1, wherein a traction means which serves for raising and lowering the lifting slide and connects the lifting slide to a drive motor.

11. The surface treatment installation of claim 10, wherein the traction means is guided via a deflection roller arranged at the upper end of the lifting station.

12. The surface treatment installation of claim 10 wherein the traction means is a cable or a belt.

13. The surface treatment installation of claim 12, wherein a block-and-tackle which reduces the force required to raise the lifting slide.

14. The surface treatment installation of claim 10, wherein the drive motor is separated from the guiding uprights by a protective wall.

15. The surface treatment installation of claim 14, wherein the protective wall has openings, through which the traction means are guided through the protective wall.

16. The surface treatment installation of claim 15, wherein a deflection roller which deflects the traction means is situated between the guiding uprights and the openings.

17. The surface treatment installation of claim 1, further comprising a cable-controlled sensor for measuring the height of the lifting slide relative to a reference point.

18. The surface treatment installation of to claim 17, further comprising a stationary reference point switch which cooperates with the cable-controlled sensor and enables alignment of the height information ascertained by the cable-controlled sensor with the reference height at which the reference point switch is arranged.

19. The surface treatment installation of claim 1 wherein the supporting structure is connected to a stationary supporting arrangement in the vicinity of the upper end of the lifting station.

20. The surface treatment installation of claim 1, wherein the guiding uprights are connected to a horizontal foot which can be fastened to a building floor and extends in the direction of the loading arm.

21. A lifting station for vertically displacing an object, in particular a vehicle body, in a surface treatment installation, comprising:
) a stationary supporting structure with two vertical guiding uprights;
a lifting slide which is supported on the supporting structure via guiding rollers bearing against the guiding uprights at least at two points; and,
a loading arm which is fastened to the lifting slide and serves for receiving the object,
wherein at least one guiding roller has a non-cylindrical shape in order to obtain a guiding direction different from a racial direction.
